(19) United States
(12) Patent Application Publication
(10) Pub. No.: US 2006/0147589 A1
(43) Pub. Date: Jul. 6, 2006

(54) Process for inhibiting enzymatic activity

(76) Inventor: Franco Cataldo, Roma (IT)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 10/542,111

(22) PCT Filed: Jan. 15, 2004
(86) PCT No.: PCT/IB04/00088

§ 371 Date: Nov. 15, 2005

(30) Foreign Application Priority Data
Jan. 15, 2003 (IT) RM2003A000014

(51) Int. Cl. A23B 4/03; A23L 1/18

(52) U.S. Cl. 426/465; 426/625

(57) ABSTRACT

A process for inhibiting enzymatic activity in a substrate in liquid phase by the application of a denaturing means to the substrate up to a temperature set between 0 and 60° C., preferably set between 10 and 50° C., and more particularly at room temperature. As the denaturing means either the application to the substrate of gaseous ozone or the application to the substrate of UV waves for a predetermined time are provided. UV waves and gaseous ozone may also be provided as a combined denaturing means, at the same time or in different times, generated by the same device. Examples of the substrate to which the invention is applied can be: a food matrix, such as vegetable juice or puree, fruit juice or puree; a pure enzyme or a mixture of enzymes in liquid phase, in particular contained in liquid food; enzymes and mixture of reagents used for biochemical synthesis; and waste material where inhibiting the enzymatic activity is necessary before disposal. The process does not damage or affect the substrate and do not apply heat, and successfully inhibits the enzymatic reactions caused by enzymes present in the substrate. The advantage of working at a temperature less than 60°, and preferably at room temperature, implies less energy absorption since the substrate must not any more be heated and cooled as required by traditional techniques, as well as it does not affect the characteristics, vitamins and fragrances of the treated food substrates.

### FIELD OF THE INVENTION

The present invention describes methods suitable for inhibiting enzymatic activity in biochemical industry where in general enzymatic reactions have to be controlled and especially in food, cosmetic, and pharmaceutical industries.

More particularly, the invention relates to a process for inhibiting enzymatic activity during the production of puree and juice food.

### BACKGROUND OF THE INVENTION

Enzymes are complex protein molecules that carry out precise catalytic functions within certain biochemical reactions. They are sequences of monomer units consisting of amino acids but also have an essential secondary and tertiary structure (three-dimensional). Such a structure gives to enzymes a considerable catalytic activity with respect to many chemical reactions that occur in living organisms. Normally, an enzymatic reaction takes place in the following way: an enzyme combines with a reagent, i.e., said substrate, forming an enzyme-substrate complex, which then changes into an enzyme-product complex and in turn splits into product and enzyme free from each other, ready to react with another molecule of substrate.

The process may take place very quickly; in many cases a single molecule of enzyme is capable of transforming into product in a very short time thousands of molecules of substrate. A reaction catalyzed by an enzyme can be up to 1000 times quicker than the same reaction but not catalyzed.

In biochemical industry enzymatic reactions play a primary role and in particular are used to control and sometimes inhibit enzymatic reactions after that they have completed their task or, simply, when they are undesired.

In the food industry, in certain known production processes of fruit juice, for example, some enzymatic reactions are used among which peptization of pectin where suitable enzymes such as pectinase are added. Such an enzymatic digestion allows a complete extraction of the juice and to prevent it from mucilage growth.

In many other cases, always in the food industry, properly inhibiting enzymatic activity allows not only an appropriate processing but also a long food conservation for example of vegetable or animal puree, fruit juice, syrups and other types of liquid food, for example, tomato juice and milk.

A common technique for inhibiting enzymatic activity, especially in the food industry, consists of pasteurization. Pasteurization provides heating the food substrate (either juice or fruit or other) up to a temperature set between 60 and 90° C. and more for a time variable according to the substrate to treat. For example, tomato juice heated up to 121° C. for 0.7 minutes for inhibiting Bacillus coagulans [Kirk-Othmer Encyclopaedia of Chemical Technology 3rd Ed. J. Wiley & Sons, Vol. 11, p. 300]. In fact, heating can cause permanent modifications in the secondary or tertiary structure of the proteins that make up the enzymes such that their catalytic activity is stopped, causing a denaturation and then inhibiting the enzymatic activity.

Concerning fruit, a process for inhibiting enzymatic activity by heating is described in EP0850572, relative to vegetable or animal puree, capable of giving the product a controlled exposition to heat.

Inhibiting enzymatic activity by heating, however, can be used only where a short heating does not damage or affect too much the food substrate. In any case, the application of heat to a food substrate, for example a juice or a vegetable or animal puree, changes the organoleptic features and destroys partially or completely thermo-sensitive vitamins.

### SUMMARY OF THE INVENTION

It is therefore a feature of the present invention to provide a process for inhibiting enzymatic activity that does not damage or affect too much the substrate.

It is another feature of the present invention to provide a process for inhibiting enzymatic activity that do not apply heat.

According to one exemplary embodiment of the invention, a process is provided for inhibiting enzymatic activity in a substrate in liquid phase in order to stop or inhibiting the course of enzymatic reactions caused by enzymes present in said substrate, the process comprising the step of denaturing the enzymes by the application of a denaturing means to the substrate up to a temperature set between 0 and 60° C., preferably set between 10 and 50° C., and more particularly at room temperature.

In a first exemplary embodiment the denaturing step provides the application to the substrate of gaseous ozone as the denaturing means.

In a second exemplary embodiment the denaturing step provides the application to the substrate of UV waves as a denaturing means for a predetermined time.

The application may also be provided to the substrate of UV waves and of gaseous ozone as a combined denaturing means, at the same time or at different times. In this case the combined denaturing means can be generated by a same device that is both a source of UV waves and an ozone generator.

The step of application to the substrate of UV waves is carried out at a predetermined frequency and intensity where said UV waves produce ozone in said substrate.

The substrate to which the invention is applied can be selected from the group consisting of a food matrix; a pure enzyme or a mixture of enzymes in liquid phase; enzymes contained in fruit juice or other liquid food in a real matrix; enzymes and mixture of reagents used for biochemical synthesis; and waste material where inhibiting the enzymatic activity is necessary before disposal.

The food matrix can be selected from the group consisting of vegetable juice, vegetable puree, fruit juice, and fruit puree.

According to preferred embodiments of the invention, radiating with UV waves or treating with ozone or the combination of the two treatments allows denaturing enzymes and then inhibiting the enzymatic activity in food substrates at room temperature.

The advantage of working at room temperature implies less energy absorption since for example fruit juice must not any more be heated and cooled as the traditional techniques require. Furthermore, the treatments proposed with the present invention, acting at a temperature less than 60°, and preferably at room temperature, do not affect the characteristics, vitamins and fragrances of the treated food substrates.

### BRIEF DESCRIPTION OF THE DRAWINGS

The invention will now be described with reference to some not limitative examples with reference to FIGS. 1, 2 and 3, wherein:

FIG. 1 shows a hydrolysis chart of saccharose into glucose and fructose by means of invertase enzyme and the effect of denaturing the enzyme by means of UV waves;

FIG. 2 shows a hydrolysis chart of saccharose into glucose and fructose by means of invertase enzyme and the effect of denaturing the enzyme by means of UV waves at an intensity higher than the case of FIG. 1;

FIG. 3 shows a hydrolysis chart of saccharose into glucose and fructose by means of invertase enzyme and inhibiting the latter by means of ozone.

### DESCRIPTION OF THE PREFERRED EXEMPLARY EMBODIMENTS

In order to show the effectiveness of inhibiting enzymatic activity according to the invention, a model enzymatic reaction is selected and the effect is studied of physical treating (UV irradiation) or chemical treating (treatment with ozone) standard saccharose solutions in particular the reaction of saccharose inversion. Saccharose is a common table sugar and is a disaccharide consisting of the union of a molecule of glucose with one of fructose. The invertase enzyme (also called saccharase) is a protein that is obtained for example by the saccaromyces cerevisiae micro organism, and consists of a mixture of two proteins, α-glicoxydase and β-h-fructoxydase. Invertase enzyme is a hydrolase that is capable of driving the reaction of fission of saccharose into two components, i.e., glucose and fructose. This enzymatic reaction can be carried out in aqueous phase in many real substrates, for example, in fruit juice. In the present example the reaction has been made using standard solutions of saccharose. The reaction of fission of saccharose into glucose and fructose is called a reaction of sugar inversion, since saccharose has optical activity and has the ability of rotating the plane of polarized light with a [α]_{D}=+66.5, whereas the products of the reaction, i.e., the glucose and the fructose, have respectively a [α]_{D}=+52,5 and [α]_{D}=−92,09. Thus, at the end of the reaction the products will have globally a value of [α]_{D}=−20,2. Since the reaction has a reagent at start that can rotate the plane of polarized light in a positive direction and forms a mixture of products that instead rotate the plane of polarized light in a negative direction, the reaction is known as sugar inversion. The reaction of inversion can be then followed easily by a polarimeter as is known to those skilled in the art.

### Examples on Experimental Substrates

### Example 1

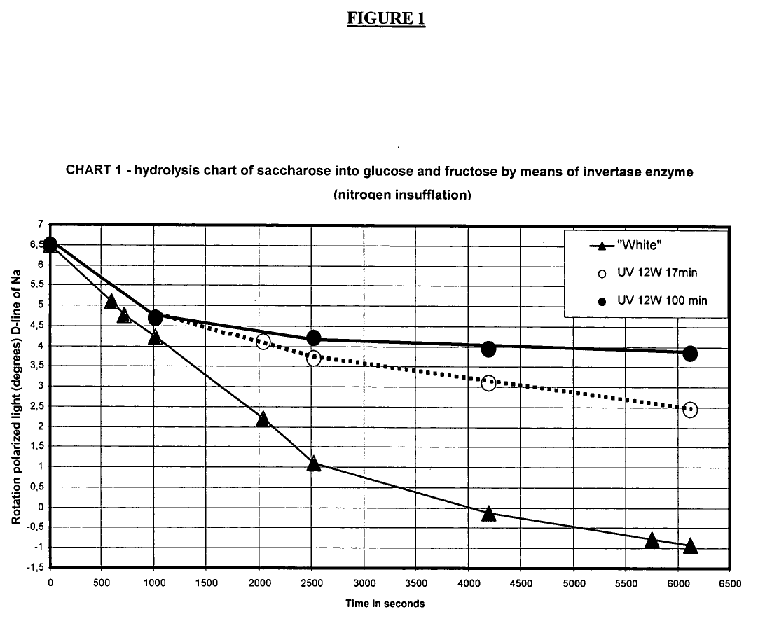

A 10% solution of saccharose (200 ml) at room temperature having a 6,50° starting rotation of polarized light α, acidified with 8 droplets of 90% acetic acid to which 65 mg of invertase enzyme (Fluka) are added and stirred to dissolve/disperse the enzyme. 150 ml of a mixture of the reagents are put immediately after mixing in a photochemical reactor having a source of UV light emitted from a low pressure 12 W mercury vapour lamp. The solution is immediately irradiated with UV and a flow of N₂ is insufflated in the solution under irradiation. The remainder 50 ml of the starting solution are not irradiated and are used as “white” or reference sample. The reaction of inversion is followed at a polarimeter both for the irradiated solution with UV and for the “white” sample. The results are given in the chart of FIG. 1.

From the chart of FIG. 1 it can be understood that in the first 1,000 seconds of irradiation there are not relevant effects in the kinetics of the inversion reaction. However after 15 minutes a considerable deceleration in the reaction speed of the irradiated solution occurred whereas the solution not irradiated has a normal kinetic course. If, after 17 min the irradiation ceases the kinetics of the reaction is described by light dots, whereas, if irradiation continues also after 17 min the kinetical trend is shown by dark dots. The comparison between light dots and dark dots shows that already at 17 min of irradiation the enzymatic reaction is remarkably inhibited with respect to the “white”, but prolonging the irradiation (dark dots) after 17 minutes implies inhibiting the enzymatic activity more completely.

### Example 2

The same test described in Example 1 was repeated exactly in the above described conditions, but omitting insufflation with nitrogen in the irradiated solution and carrying out irradiation in static air. The effect has practically equivalent results. The example shows that the irradiation in nitrogen or in air is equivalent for invertase enzyme.

### Example 3

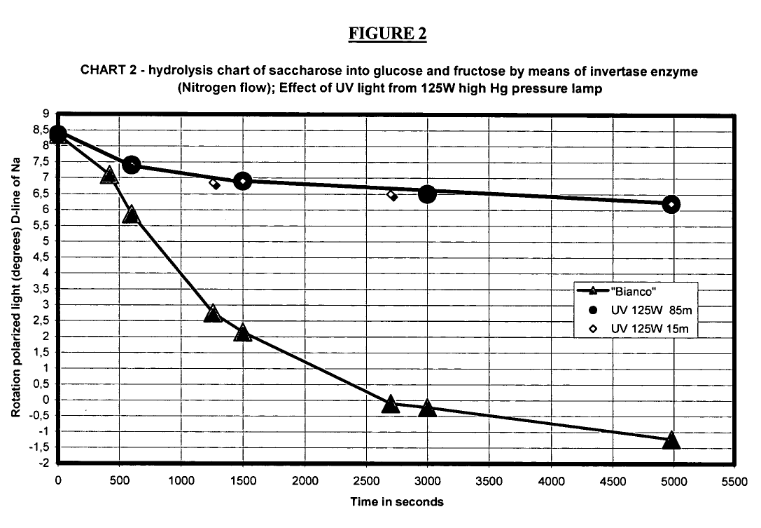

The same test described in Example 1 was repeated with nitrogen on a solution of saccharose having a rotation starting value of polarized light α=8.35°, using a photochemical reactor having a UV source of 125 W at medium-high Hg pressure instead of the 12 W source of the previous examples. Even in this case the reaction of inversion is tracked polarimetrically in comparison with a “white” sample of not irradiated solution. The results are shown in the chart of FIG. 2.

Using a more powerful source of UV light as the 125 W lamp at medium-high Hg pressure, the inhibition on the invertase enzyme is clear in less than 10 minutes as can be seen by the trend of the inversion reaction kinetics (dark dots) in comparison with the not irradiated reference reaction kinetics (triangles). The inhibiting action of the 125 W lamp is complete and definitive with respect to that of examples 1 and 2. If the irradiation is discontinued after 19 minutes (rhombs), the inversion reaction kinetics is in any case inhibited and the same occurs in a solution irradiated for 85 minutes (dark dots). Even in this case, the inhibiting action of UV light on the invertase enzyme and then on the inversion reaction is evident, clear and distinct.

### Example 4

A 10% solution of 200 ml of saccharose in water having a starting rotation value of polarized light α=7.20° is put in 4 different vessels containing 50 ml each of starting solution, at a temperature of 25° C.

Solution 1 is not treated with ozone.

Solution 2 is treated with O₃ up to a nominal concentration of about 50 mg O₃/litre insufflating air containing ozone at 17%.

Solution 3 is treated with O₃ up to a nominal concentration of 12 mg O₃/litre in the same way as for Solution 2.

Solution 4 is treated with O₃ up to a nominal concentration of 3 mg O₃/litre in the same way as for Solution 2.

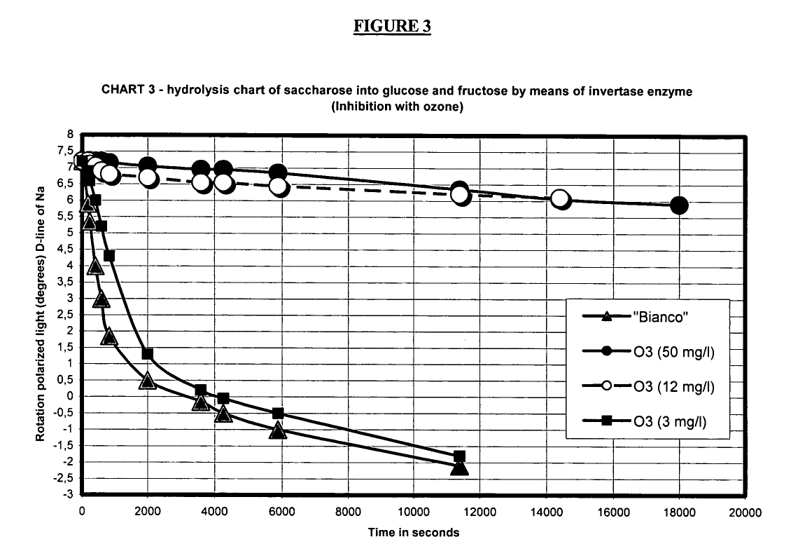

Once ready, to all the Solutions 1-4, 48±2 mg of invertase enzyme have been added. The reaction kinetics were followed polarimetrically. The results are shown in the chart of FIG. 3. From the chart it is clear that Solution 1, corresponding to the “white” sample (triangles), is subject to a normal reaction of inversion. Solution 4 treated with 3 mg O₃/litre shows only a slight delay in the reaction kinetics with respect to the “white” sample, demonstrating that at that concentration ozone has not a significant inhibiting effect on invertase enzyme. However, Solutions 2 and 3 respectively 50 and 12 mg O₃/litre show instead a full inhibition of the inversion reaction of saccharose. Particularly interesting is the result obtained with only 12 mg O₃/litre that appears to be a minimum threshold from which it is possible to inhibit completely the action of invertase enzyme.

### Examples on Real Substrates

Examples 1-4 have shown that both UV radiation and ozone carry out a denaturation capable of inhibiting completely the action of the invertase enzyme.

UV radiation is a physical means suitable essentially for treatment of limpid substrates and in any case of substrates that are transparent to these waves. If the substrates are opaque a treatment is possible of irradiation of a thin film of the substrate same. The UV radiation is absorbed by the proteins and the denaturing effect is shown by a plurality of reactions (reticulations, degradations, isomerisms) that affect both the primary structure of the enzymatic protein and the secondary and tertiary structures. A minimum, but permanent, alteration of the structure of the protein causes necessarily a denaturation of the enzyme that then is permanently inhibited from driving a certain reaction.

The ozone instead is a chemical means and is a powerful oxidant. Surprisingly, it is very effective and safe in inhibiting the enzymatic activity and it can applied in case of all food substrates, also opaque or heterogeneous substrates, provided it is distributed suitably in them. Ozone, then, is instable and slowly decomposes spontaneously into oxygen whereby its concentration becomes void in the treated substrates in a few hours.

In the following examples the results of some experiences are shown concerning the effect of the ozone on real substrates. Fruit juice and fruit puree have been used, even if the examples are to be intended not limitative for the extent of the invention, which can be applied to a desired food substrate or chemical process that involves enzymatic reactions.

### Example 5

The present example relates to 50 ml of apple juice obtained by milling and filtering “golden” apples. Immediately after filtration the juice has been divided into two samples and transferred into two sterilized transparent bottles and closed. In one of the two bottles ozone was insufflated before closing. The apple juice treated with ozone did not darken but it maintained its original yellow-golden colour whereas the reference sample, not treated, turned quickly into brown. The fact that ozonized juice do not darken shows that the activity of enzymes that cause the darkening of fruit juice (so called “polyphenol oxidase”, see J. J. Macheix et al. “Fruit Phenolics”, p. 296, CRC Press, 1990 Boca Raton, Fla.) have been inhibited by treatment with ozone. Treating with ozone prevents also a growth of mold. The sample of juice not treated with ozone develops molds on the surface already after 4 days after bottling whereas the sample treated with ozone does not develop any mold even after 40 days from the bottling.

### Example 6

Example 6 has been made on apple juice obtained by milling “golden” apple pulp and then filtrating it. Each experiment has been made on 25 ml of apple juice in a 50 ml Pyrex vessel having a valve for vacuum. The vacuum has been made with a water pump. The reference sample was simply transferred and closed in the Pyrex vessel without any treatment. After 4 days said sample developed mold, showed fermentation and remarkably darkened. The sample of apple juice treated with ozone was prepared by a process comprising making vacuum in the vessel containing the juice and then putting oxygen containing 10% ozone for a time of 20-30 seconds. During this time the apple juice was stirred and then evacuated again to the pump for a second treatment similar to the previous. As expected, the introduction of ozone did not cause darkening and allowed the apple juice to remain light, and inhibited “polyphenol oxidase” enzymes. After 4 days, but also after weeks, mold growth was not observed and smell and taste remained good. Treating with ozone also inhibited completely fermentation of the juice that instead was observed, as already said, in the sample of reference. It is known that fermentation is an enzymatic reaction caused by yeasts. It is apparent that the ozone inhibited completely the enzymatic functions of such micro-organisms acting then also as steriliser. It is also interesting to note other two points: First, owing to the short contact time, less than half of the ozone delivered reacts with the substrate, as it is possible to measure iodometrically, whereas the remainder is recovered and used again. Second, another interesting aspect is that after 4 days, the juice is completely free from ozone, both free ozone and in the form of peroxides, as verified with the KI test (absence of iodine as free element).

### Example 7

A peach puree was prepared by milling a peach pulp. The puree obtained was divided into two 50 ml parts. One part was bottled as such, and one part was bottled after treatment with ozone in the same way as described in previous Example 6. Also in this case treating the puree with ozone at bottling inhibits darkening of the puree due to action of “polyphenol oxidase” enzymes, avoiding also the growth of mold and fermentation of the puree, which instead were observed in the reference samples.

### Example 8

Also surprising was the behaviour of the peach puree left in air in a not sterile environment. A peach puree (50 ml) was prepared milling a peach pulp and then was divided in two parts and left in two glasses in air at room temperature. One of the two samples was treated with a flow of ozone by means insulation in the mass. It is possible to observe, in 24 hours time, even in air, that the treatment with ozone delays the mold growth in the puree. On the contrary, the sample not treated with ozone shows quick mold growth with large quantity of mold. Instead, in the case of the sample treated with ozone, in addition to a delay of several days in mold growth, such a growth was observed as very slow and difficult.

Examples 5-8 have been carried out at room temperature and in an air atmosphere. Obviously, for particular applications in case of only UV irradiation it can be carried out in artificial reactive or not reactive atmosphere around the substrate under irradiation.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

What is claimed is:

1. A process for inhibiting enzymatic activity in a substrate in liquid phase, in order to stop or inhibiting the course of enzymatic reactions caused by enzymes present in said substrate, comprising the step of denaturing said enzymes, said denaturing step providing the application of denaturing means to said substrate up to a temperature set between 0 and 60° C.

2. The process of claim 1, wherein said denaturing step is carried out at a temperature set between 10 and 50° C.

3. The process of claim 1, wherein said denaturing step is carried out at room temperature.

4. The process of claim 1, wherein said denaturing step provides the application to said substrate of gaseous ozone as denaturing means.

5. The process of claim 1, wherein said denaturing step provides the application to said substrate of UV waves as denaturing means for a predetermined time.

6. The process of claim 1, wherein said denaturing step provides the application to said substrate of UV waves and of gaseous ozone as combined denaturing means.

7. The process of claim 6, wherein said combined denaturing means is generated by a same device that is both a source of UV waves and an ozone generator.

8. The process of claim 6, wherein the application to said substrate of UV waves and of gaseous ozone as denaturing means is carried out in different times.

9. The process of claim 5, wherein the step of application to said substrate of UV waves is carried out at a predetermined frequency and intensity at which said UV waves produces ozone in said substrate.

10. The process of claim 1, wherein said substrate is selected from the group consisting of a food matrix, a pure enzyme or a mixture of enzymes in liquid phase, enzymes contained in fruit juice or other liquid food in a real matrix, enzymes and mixture of reagents used for biochemical synthesis, and waste material where inhibiting the enzymatic activity is necessary before disposal.

11. The process of claim 1, wherein said food matrix is selected from the group consisting of vegetable juice, vegetable puree, fruit juice, and fruit puree.
